(19) United States
(12) Patent Application Publication
(10) Pub. No.: US 2014/0032043 A1
(43) Pub. Date: Jan. 30, 2014

(54) METHOD AND APPARATUS FOR CONTROLLING MASSAGE FUNCTIONS OF A MOTOR VEHICLE SEAT

(71) Applicant: Ford Global Technologies, LLC, Dearborn, MI (US)

(72) Inventors: Johnathan Andrew Line, Northville, MI (US); Steve Michell, Commerce, MI (US); Jeroen Lem, Maastricht (NL); Florian Golm, Herzogenrath (DE); John Gerald Kaminski, Dearborn, MI (US); Stefan Wolter, Aachen (DE)

(21) Appl. No.: 13/951,174

(22) Filed: Jul. 25, 2013

(30) Foreign Application Priority Data
Jul. 27, 2012 (DE) 102012213285.6

(51) Int. Cl. B60N 2/44

(52) U.S. Cl. CPC B60N 2/448
USPC 701/36

(57) ABSTRACT

A method for selecting and controlling massage functions of a motor vehicle seat having a control system comprising the steps of: switching the system to a selection mode and starting the selection mode; providing a menu list having options for querying the user's requirements during the massage; selection of an option by the user and providing predefined responses to the respective query and selection of the response by the user and if necessary repeating the steps for further queries; and terminating the selection mode and automatically determining suitable massage settings on the basis of the user's selection and controlling the massage actuators in the motor vehicle seat on the basis of determined massage settings to perform the massage function.

### FIELD OF THE INVENTION

The invention relates to a method for selecting and controlling massage functions of a motor vehicle seat and a corresponding device. The object of this invention is to provide a method for controlling and selecting massage functions of a motor vehicle seat, which method renders possible a simple and intuitive adjustment. This object is achieved by way of the method described herein.

### BACKGROUND OF THE INVENTION

It is generally known to equip seats in motor vehicles with massage functions, for example for the lumbar supports and the actual seating surface. However, it is problematic for the user to operate the control system in a simple and intuitive manner, especially as the driver must perform the method whilst driving. It is usually necessary to reach a compromise between the variety of controls and the level of detail and also the level of simplicity and the model provided. Known systems are frequently complex and laborious to use, which results in the driver averting his or her attention in an undesired manner from steering the vehicle.

### SUMMARY OF THE INVENTION

According to one aspect of the present invention, a method for selecting and controlling massage functions provided to a user in a motor vehicle seat having a control system includes the steps of switching the system to a selection mode and starting the selection mode. A menu list is provided having options for querying requirements of a user during a massage. Predefined responses are provided to the respective query. The response is selected by the user and if necessary the steps for further queries are repeated. The selection mode is terminated. Suitable massage settings are automatically determined on the basis of the selection of the user. Massage actuators are controlled in the motor vehicle seat on the basis of determined massage settings to perform the massage function.

According to another aspect of the present invention, a method for operating a massage assembly for a motor vehicle seat includes the steps of starting a selection mode and querying massage preferences of a user. Predefined responses are provided to each preference for selection by the user. The selection mode is terminated and suitable massage settings are provided based on selections of the user. Massage actuators are controlled in the motor vehicle seat based on the massage settings to perform a massage function.

According to yet another aspect of the present invention, a vehicle seating assembly massage device includes a seat and a seatback. An interface includes a display. A control is operably coupled to the display. Massage preferences are provided to a user by the display. The control provides predefined responses to each preference for selection by the user. Seat and seatback massage actuators are coupled to the control and are configured to receive instructions from the control to perform a massage function.

These and other aspects, objects, and features of the present invention will be understood and appreciated by those skilled in the art upon studying the following specification, claims, and appended drawings.

### BRIEF DESCRIPTION OF THE DRAWINGS

Further features and details of the invention are evident from the following description of the drawing, in which:

FIG. 1 illustrates a perspective and schematic view of a motor vehicle seat;

FIG. 2 illustrates an exemplary menu for querying whether the user is suffering any pain;

FIG. 3 illustrates a query with the support of an avatar;

FIG. 4 illustrates a schematic flow diagram for selecting and controlling massage functions of the motor vehicle seat; and

FIG. 5 illustrates a further schematic flow diagram for selecting and controlling massage functions of the motor vehicle seat.

### DETAILED DESCRIPTION OF EMBODIMENTS

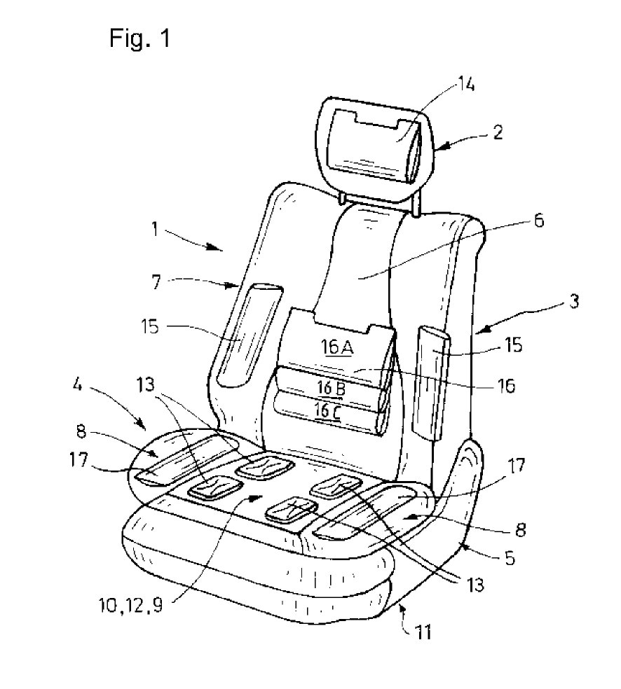

For purposes of description herein, the terms “upper,” “lower,” “right,” “left,” “rear,” “front,” “vertical,” “horizontal,” and derivatives thereof shall relate to the invention as oriented in FIG. 1. However, it is to be understood that the invention may assume various alternative orientations, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

In accordance with the invention it has become known, that an extensive simplification of the selection method and intuitive operation can be achieved if, within the framework of the method for selecting and controlling massage functions massage functions of a motor vehicle seat that includes a control system, a menu list is provided in the selection mode, which menu list includes options for querying the user's requirements during the massage, the user selects an option and for this purpose the menu list displays predefined responses to the respective query and the response is selected by the user (from the responses provided). If necessary, these steps are repeated for further queries. Finally, the selection mode is terminated, suitable massage settings are automatically defined on the basis of the response selected by the user and the massage actuators in the motor vehicle seat are activated to perform the massage function on the basis of the specific massage settings. In other words, the user is purposefully consulted and can select from the options provided. A massage is defined on the basis of the user's responses and the actuators in the vehicle seat are correspondingly activated. As a consequence, the user is guided to the appropriate and desired setting of the massage functions.

In one embodiment, the options include queries relating to physical ailments and/or pains that can be alleviated by means of a massage. Predefined responses are provided in accordance with the invention. The predefined responses include a list of the ranges of the respective physical ailments and/or pains that can be alleviated. In one aspect of the invention, the user is initially queried to determine whether the user is in pain. As a response, a list appears that specifies back, neck, pelvis or buttock pains and/or stiffness or numbness etc. In addition, it is expedient if the options list includes queries relating to the physical characteristics (such as weight, age, height etc.) of the user. A list of ranges of the respective physical characteristics is in turn provided for the user to make a selection from the predefined responses. In addition, it is desired if the menu list includes the option for the user to select his or her desired massage characteristics and if the predefined responses include information relating to usual massage characteristics (a heavy massage, a gentle massage, more pressure on top or lower down etc.).

In another embodiment, interaction with the user (options, responses, etc.) is performed with the support of an avatar. An avatar is an artificial person or graphic representation of a real person in the virtual world, for example in a computer. The graphic representation exists to reduce the inhibition threshold of the interaction and to facilitate the interaction. The graphic representation can be supported and/or guided by speech while implementing and/or accepting the options and responses. A menu list is provided in an expedient manner, which menu list includes options for querying the user's requirements during the massage and provides the user with the facility to respond to the query. The menu list provides predefined responses to the respective query and to the selected response provided by the user and if necessary the menu list repeats the step for further queries using a display device and an operating element. It is contemplated that interface devices, such as an LCD display, a touch screen display, and a loudspeaker, can be used as a possible display device. 5-position buttons and touch screen displays and microphones have each proven to be possible operating elements. It is also feasible to control the system by way of so-called mobile phone apps (programs) by way of which the mobile phone is able to control the system remotely.

With reference to the embodiment generally illustrated in FIG. 1, reference numeral 1 generally designates a seat in accordance with the present invention, wherein the transparency renders a view of the interior of the seat possible. The seat 1 includes a head support 2, which head support is arranged at the top on a back rest 3, which back rest is in turn coupled to the actual seat 4 by way of a hinge joint 5 that can be adjusted. In this case, the seat 1 is supported by a sheet steel frame 11, which frame is arranged under the actual seating surface and is connected to the vehicle. The back rest 3 includes an overlay 6 that includes an approximately S-shaped longitudinal section, which overlay is anatomically formed for the back of the occupant and is delimited at the sides by protruding fins 7 that provide the occupant with lateral support. The actual seat 4 likewise includes an overlay 9 that defines the actual seating surface. Protruding fins 8 are also provided on the sides in this case, which fins provide the occupant with support, in particular as the vehicle negotiates bends. The overlay 9 is embodied from a foam block 10 formed from a suitable natural—and/or synthetic material, which can be upholstered using a suitable material such as leather. It is necessary for the overlay to include the conventional and known characteristics, such as to provide cushioning, to absorb shocks, to transport moisture etc. In addition it is possible to provide heating and/or cooling devices in the overlay.

A support plate 12 that is embodied from a stiff material is provided under the foam block 10, as can be easily recognized in FIG. 1. The support plate 12 in this case is arranged under the rear region of the seating surface, which is generally occupied by the buttocks of the occupant. An air cushion 13 is provided under the support plate 12 and above the frame 11, in other words between the support plate 12 and the frame 11, which air cushion by way of a controller, not illustrated, valves and compressor renders it possible to adjust and improve the shock absorbing characteristics of the seat by means of adjusting the air pressure even when the vehicle is travelling. The controller can automatically regulate the air pressure in the air cushion 13 after the data that is provided by the sensors regarding the driving situation and the occupant has been evaluated. A manual adjustment, input or intervention into the automatic control process is also feasible.

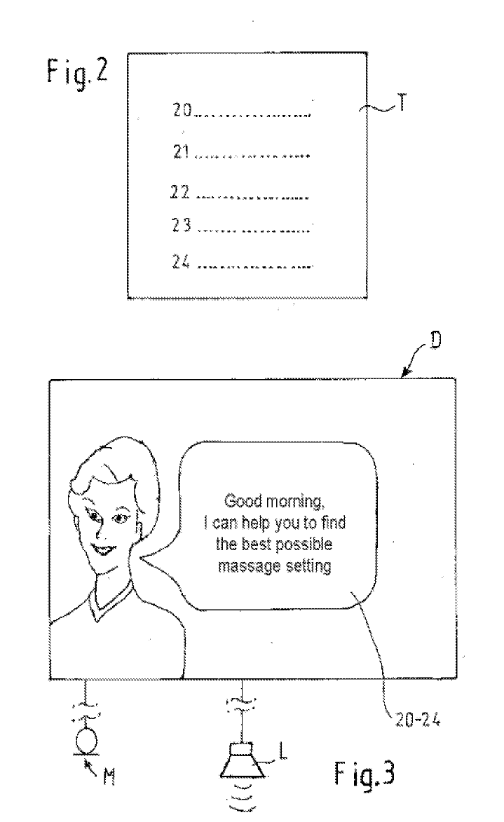

The seat 1 also includes further air cushions 15, 17, 16 and 14 in the fins 7 and 8, the overlay 6 and the head support 2, which air cushions are used to perform the massage and to adjust the contour. The air cushions can likewise be used and/or regulated by way of the previously mentioned controller. In addition in the event of a vehicle collision, the air cushions can be inflated and used as additional impact protection, in order to prevent the occupant making contact with the metal frame 11 of the seat. Four additional air cushions 13 are provided under the actual seat 9 between the support plate 12 and the frame 11. The air cushions are arranged in this case in such a manner, that they lie under the corners of the approximately rectangular seating surface. The four mutually independently controllable and inflatable air cushions 13 under the support plate 12 vertically position the support plate 12 make it possible to tilt the support plate 12 about two axes that extend parallel to the plane of the seat surface and that extend perpendicular relative to one other. As a consequence, the pelvis of the occupant can be tilted from the front towards the rear and from the rear towards the front. This is relaxing and is used, for example, during spinal gymnastics. It is particularly helpful to tilt the pelvis in this manner in order avoid back pain. This movement can be coupled with a tilting movement from left to right, so that the fatigue associated with the pelvic movement caused by the alternating periodic tensing and relaxing of muscles is avoided in a particularly efficient manner. As a consequence, it is clear that extremely different massage shapes, intensities and duration periods are possible by virtue of the programmed control of the air cushions and zones. By way of example, the method for selecting and controlling massage functions is described below with reference to FIGS. 2-4. An exemplary menu M to query the existence of pain and/or physical ailments having predefined responses for selection by the user using a touch screen display T of a motor vehicle dashboard is illustrated in FIG. 2.

In one embodiment, as illustrated in FIG. 2, pain and/or physical ailments in the lower back region 20, pain in the upper back region 21, tensing of back muscles 22, back stiffness 23 and numbness of the buttocks 24 are options listed for the user to make a selection by means of pressing and/or touching the corresponding response field. The computer in the massage control system ascertains the optimal massage for alleviating the pain with reference to the field that is selected by the user. For example, as noted above, the user may touch the display, provide verbal input, etc., and the air cushions 13 to 17 are controlled accordingly. A corresponding query that is supported by an avatar A on a display D is illustrated in FIG. 3, wherein the process of querying the physical ailments 20-24 is supported by speech by way of a loudspeaker L and the input is provided by way of a microphone M.

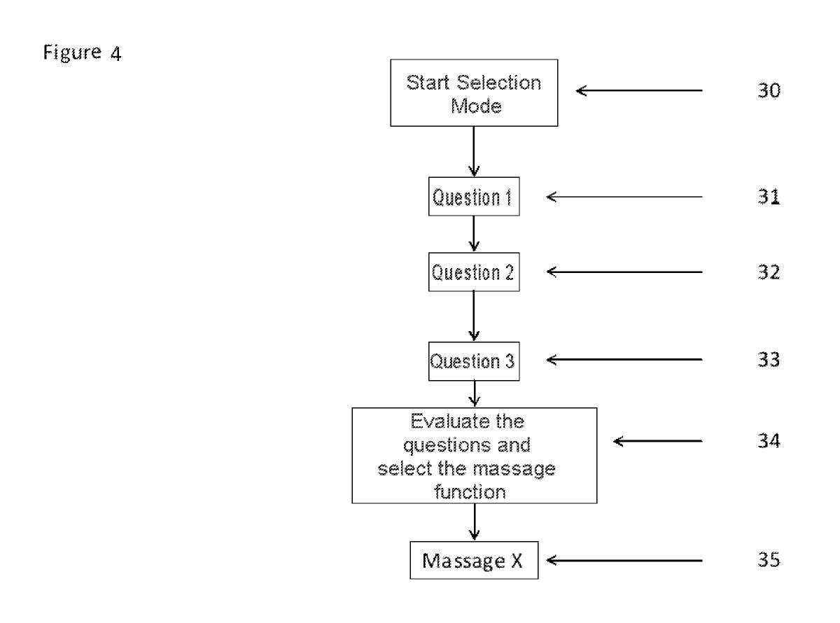

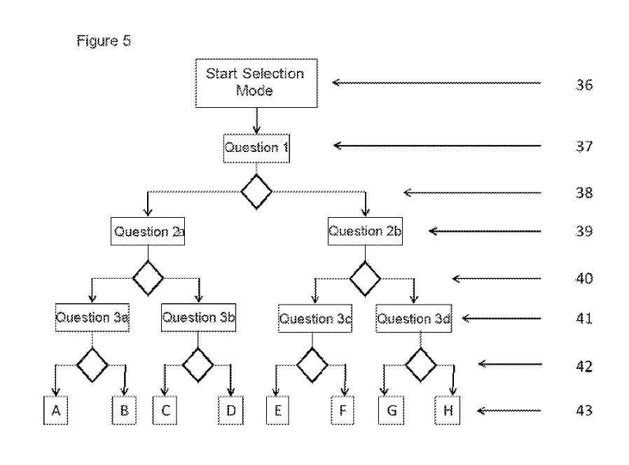

FIG. 4 is a schematic flow diagram of the method in accordance with the invention for selecting and controlling massage functions of the motor vehicle seat illustrated in FIG. 1 by way of the touch screen display T illustrated in FIG. 2. The selection mode is initially started in step 30 and then the first question is posed in the next step 31, for example a menu M is displayed on a touch screen display T of a motor vehicle dashboard for querying the existence of pain and/or physical ailments with predefined responses for selection by the user. In step 31, pain and/or physical ailments in the lower back region 20, pain in the upper back region 21, tensing of back muscles 22, back stiffness 23 and numbness of the buttocks 24 are listed for the user to make a selection by means of pressing and/or touching the corresponding response field. The response is fixed in step 31 by the user touching the screen display to select the field. In the steps 32 and 33, a number of questions follow in a similar manner, in this example there are three more questions. Finally, in step 34, the optimal massage for alleviating pain is defined by the computer in the massage control system (x). For this purpose, a database of comparative values is consulted, the values are compared with the user's responses and subsequently the optimal massage function is selected. In step 35, the air cushions 13 to 17 are controlled accordingly.

FIG. 5 is a schematic flow diagram of the method in accordance with the invention for selection and control of massage functions of the motor vehicle seat in FIG. 1 with reference to the touch screen display T illustrated in FIG. 2. The selection mode is initially started in step 36 and then the first question is posed in the next step 37, for example a menu M is displayed on a touch screen display T of a motor vehicle dashboard for querying the existence of pain and/or physical ailments with predefined responses for selection by the user. In step 37 pain and/or physical ailments in the lower back region 20, pain in the upper back region 21, tensing of back muscles 22, back stiffness 23 and numbness of the buttocks 24 are listed for the user to make a selection by means of pressing and/or touching the corresponding response field. The response is fixed in step 38 by the user touching the screen display to select the field. A second question is posed by the computer of the massage control system in step 39 depending upon the response to the question in step 38. A response can also be given here in a similar manner to that in step 38, whereupon further questions can follow. In FIG. 5, a third question is then posed in step 41. In step 43, the optimal massage for alleviating the ailments of the user and/or to allow the user to rest is determined according to the response in step 42 to the last question. The air cushions 13 to 17 are then controlled according to the selected massage.

It is to be understood that variations and modifications can be made on the aforementioned structure without departing from the concepts of the present invention, and further it is to be understood that such concepts are intended to be covered by the following claims unless these claims by their language expressly state otherwise.

It will be understood by one having ordinary skill in the art that construction of the described invention and other components is not limited to any specific material. Other exemplary embodiments of the invention disclosed herein may be formed from a wide variety of materials, unless described otherwise herein.

For purposes of this disclosure, the term “coupled” (in all of its forms, couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature or may be removable or releasable in nature unless otherwise stated.

It is also important to note that the construction and arrangement of the elements of the invention as shown in the exemplary embodiments is illustrative only. Although only a few embodiments of the present innovations have been described in detail in this disclosure, those skilled in the art who receive this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed, the operation of the interfaces may be reversed or otherwise varied, the length or width of the structures and/or members or connector or other elements of the system may be varied, the nature or number of adjustment positions provided between the elements may be varied. It should be noted that the elements and/or assemblies of the system may be constructed from any of a wide variety of materials that provide sufficient strength or durability, in any of a wide variety of colors, textures, and combinations. Accordingly, all such modifications are intended to be included within the scope of the present innovations. Other substitutions, modifications, changes, and omissions may be made in the design, operating conditions, and arrangement of the desired and other exemplary embodiments without departing from the spirit of the present innovations.

It will be understood that any described processes or steps within described processes may be combined with other disclosed processes or steps to form structures within the scope of the present invention. The exemplary structures and processes disclosed herein are for illustrative purposes and are not to be construed as limiting.

It is also to be understood that variations and modifications can be made on the aforementioned structures and methods without departing from the concepts of the present invention, and further it is to be understood that such concepts are intended to be covered by the following claims unless these claims by their language expressly state otherwise.

What is claimed is:

1. A method for selecting and controlling massage functions provided to a user in a motor vehicle seat having a control system comprising the steps of:
switching the system to a selection mode and starting the selection mode;
providing a menu list having options for querying requirements of a user during a massage;
providing predefined responses to the respective query and selecting the response by the user and if necessary repeating the steps for further queries; and
terminating the selection mode and automatically determining suitable massage settings on the basis of the selection of the user and controlling massage actuators in the motor vehicle seat on the basis of determined massage settings to perform the massage function.

2. The method of claim 1, wherein the step of providing a menu list further comprises:
providing a menu list that includes a query relating to the existence of physical ailments that can be alleviated by means of a massage.

3. The method of claim 1, wherein the step of providing predefined responses further comprises:
providing a list of ranges of the respective physical ailments that can be alleviated by means of a massage.

4. The method of claim 1, wherein the step of providing a menu list further comprises:
providing a menu list that includes a query relating to physical characteristics of the user.

5. The method of claim 1, wherein the step of querying massage preferences of a user further comprises:
providing a menu list that includes a query relating to desired massage characteristics of the user.

6. The method of claim 1, wherein the step of providing predefined responses further comprises:
providing predefined responses that include a list of typical desired massage characteristics.

7. The method of claim 6, wherein the step of querying massage preferences of a user further comprises:
providing a menu list that includes a query relating to desired massage characteristics of the user.

8. The method of claim 1, further comprising:
providing an avatar to assist in querying and soliciting responses from a user.

9. A method for operating a massage assembly for a motor vehicle seat comprising the steps of:
starting a selection mode;
querying massage preferences of a user;
providing predefined responses to each preference for selection by the user;
terminating the selection mode and providing suitable massage settings based on selections of the user; and
controlling massage actuators in the motor vehicle seat based on the massage settings to perform a massage function.

10. The method of claim 9, wherein the step of querying massage preferences of a user further comprises:
providing a menu list that includes a query relating to the existence of physical ailments that can be alleviated by means of a massage.

11. The method of claim 9, wherein the step of providing predefined responses further comprises:
providing a list of ranges of the respective physical ailments that can be alleviated by means of a massage.

12. The method of claim 9, wherein the step of querying massage preferences of a user further comprises:
providing a menu list that includes a query relating to physical characteristics of the user.

13. The method of claim 12, wherein the step of providing predefined responses further comprises:
providing a list of ranges of the respective physical ailments that can be alleviated by means of a massage.

14. The method of claim 9, wherein the step of querying massage preferences of a user further comprises:
providing a menu list that includes a query relating to desired massage characteristics of the user.

15. The method of claim 9, further comprising:
providing an avatar to assist in querying and soliciting responses from a user.

16. A vehicle seating assembly massage device comprising:
a seat;
a seatback;
an interface including a display;
a control operably coupled to the display, wherein massage preferences are provided to a user by the display, and wherein the control provides predefined responses to each preference for selection by the user; and
seat and seatback massage actuators coupled to the control and configured to receive instructions from the control to perform a massage function.

17. The vehicle seating assembly massage device of claim 16, wherein the display includes at least one of an LCD display, a touch screen display, and a loudspeaker.

18. The vehicle seating assembly massage device of claim 16, further comprising:
an operating element having one of a 5-position button, a touch screen display, and a microphone.

19. The vehicle seating assembly massage device of claim 16, wherein the control is operably coupled to and operational by a programmed mobile telephone.
